(19) United States
(12) Patent Application Publication
(10) Pub. No.: US 2020/0037759 A1
(43) Pub. Date: Feb. 6, 2020

(54) HIDEAWAY STORAGE RACK

(71) Applicant: Discovery Inc., Ross, CA (US)

(72) Inventor: Bill Ward, Ravenel, SC (US)

(21) Appl. No.: 16/528,605

(22) Filed: Jul. 31, 2019

Related U.S. Application Data
(60) Provisional application No. 62/712,967, filed on Jul. 31, 2018.

(51) Int. Cl. A47B 46/00; A47B 47/04

(52) U.S. Cl. CPC A47B 46/00; A47J 47/16; A47B 47/04

(57) ABSTRACT

A storage rack having a hidden section for storing additional items includes a stepped upper member, an open space, at least one open side, one or more slide-out trays, and a plurality of substantially vertical walls. The stepped upper member defines at least two or more steps, with each step having a substantially planar upper surface that defines a length between a left and a right side of each said step. The upper member has an upwardly facing surface and a downwardly facing surface. The open space is provided beneath the lower surface. The trays are positioned below downwardly facing surface in the open space and are slidable out of the rack. The vertical walls are coupled to the stepped upper member and extend downwardly therefrom. The walls provide a slot for receiving the slide-out trays.

### CROSS-REFERENCE TO RELATED APPLICATION

The present application claims priority to U.S. Provisional Application No. 62/712,967, filed on Jul. 31, 2018, the disclosure of which is incorporated herein by reference in its entirety.

### FIELD

The invention relates to a shelving unit that has hiding portions under the rack. In particular, the invention relates to a spice rack that has hideaway portions under the rack for storing additional spice bottles.

### BACKGROUND

Shelf-like spice racks are known. They can be step-like and include several tiers that permit spice jars or bottles that are in the back of the rack to be elevated above spice jars or bottles that are positioned on the front/lower shelves of the racks. These racks can be made of wood, bamboo, plastic (such as clear acrylic) or other materials as known by those of skill in the art.

### SUMMARY

A hideaway storage and/or spice rack is shown and described herein.

### BRIEF DESCRIPTION OF THE DRAWINGS

FIG. 1 is a front perspective view of the example storage rack in a closed configuration, with the storage rack being empty;

FIG. 2 is a side perspective view of the storage rack of FIG. 1 in a closed configuration, with the storage rack being empty;

FIG. 3 is a front/side perspective view of the storage rack of FIG. 1 in a closed configuration, with the storage rack being empty;

FIG. 4 is a front perspective view of the storage rack of FIG. 1, with bottles, such as bottles containing spices, installed on the storage rack, in a closed configuration;

FIG. 5 is a side perspective view of the storage rack of FIG. 1, with bottles installed on the rack, in a closed configuration;

FIG. 6 is a front/side perspective view of the storage rack of FIG. 1 with bottles installed on the rack, in a closed configuration;

FIG. 7 is a front perspective view of the storage rack of FIG. 1, with the storage rack being empty and in an extended configuration;

FIG. 8 is a side perspective view of the storage rack of FIG. 1, with the storage rack being empty and in an extended configuration;

FIG. 9 is a front/side perspective view of the storage rack of FIG. 1, with the storage rack being empty and in an extended configuration;

FIG. 10 is a front view of the storage rack of FIG. 1, with the storage rack being empty and in an extended configuration;

FIG. 11 is a side view of the storage rack of FIG. 1, with the storage rack being empty and in an extended configuration;

FIG. 12 is a top view of the storage rack of FIG. 1, with the storage rack being empty and in an extended configuration;

FIG. 13 is a front perspective view of the storage rack of FIG. 1, with the storage rack being in an extended configuration and with bottles installed on the storage rack.

FIG. 14 is a front/side perspective view of the storage rack of FIG. 1, with the storage rack being in an extended configuration and with bottles installed on the storage rack;

FIG. 15 is a side perspective view of the storage rack of FIG. 1, with the storage rack being in an extended configuration and with bottles installed on the storage rack;

FIG. 16 is an exploded view of the sliding mechanism of one of the slide-out trays of the storage rack of FIG. 1, showing a notch positioned on the side surface of the slide-out tray;

FIG. 17 is an exploded view of the sliding mechanism of the trays, showing rails positioned on the inner walls of the storage rack; and

FIG. 18 is an exploded bottom perspective view of the sliding mechanism of the sliding trays.

### DETAILED DESCRIPTION

The device shown and described herein is a storage rack 10 that has hidden trays 12 that permit items 14, such as bottles or cans, to be stowed inside rack 10. The rack 10 is useful with spices, since many spice bottles have approximately the same size. Alternatively, the rack 10 could be used for storing other types of food, such as canned goods 14, or bottles of food 14. The rack 10 can be sized accordingly based upon the type of goods 14 to be stored on the rack 10. While the rack 10 is often referred to herein as a “spice rack,” it should be noted that the rack 10 can be used for other types of goods, including other foods or non-food items. The word “spice rack” should not be interpreted to limit the types of goods 14 that can be stored on the rack 10.

Referring to the figures, the storage rack 10 includes a series of steps, including a lower, front step 16, a middle step 18, and an upper, rear step 20. The steps 16, 18, 20 have substantially planar upper surfaces 22 that are used for storing goods 14. While three steps are shown fewer than three steps can be used, if desired, or greater than three steps may be used, if desired. Each of the steps 16, 18, 20 provides a platform for positioning bottles or cans on the step.

The steps 16, 18, 20 of the spice rack 10 have an open space 24 below each step 16, 18, 20, as well as open sides 26. Additional spice bottles 14 can be positioned in this open space 24. To facilitate this, slide-out trays 12 are positioned below each elevated step 16, 18, 20 that allows the user to remove the spice bottles 14 from the open space 24 by sliding the trays 12 outwardly from the open space 24. The slide-out trays 12 slide through the open sides 26 of the open space 24 and additional bottles 14 can be seated on the slide-out trays 12.

When the trays 12 are slid out to reveal additional bottles 14, the trays 12 are in an extended position. The spice rack 10 can remain in an extended position if the user wishes to do so. Alternatively, once a bottle 14 is removed and/or replaced, the user can slide the trays 12 back into the open space to “close” the spice rack 10 so that the extra bottles 14 are not visible and to conserve space inside a cabinet or on a surface, such as a countertop.

As shown, the bottom step 16 does not have an open space below it because it is coupled to a bottom member 30. The bottom member 30 seats directly on an underlying surface. The middle and upper steps 18, 20 both have an open space 24 below them. Bottom member 30 is substantially planar and is coupled to the stepped upper member at the front and rear of the spice rack 10. The bottom member 30 helps to stabilize the spice rack 10 by providing support between the front and rear of the spice rack 10.

The spice rack 10 also includes legs or walls 32 that extend downwardly from the upper stepped portion of the rack 10 and that join with the bottom member 30. One of the walls is a rear wall 34 that encloses the rear of the spice rack 10 and that extends downwardly from the rear edge of the rear step 20. The rear wall is substantially perpendicular to the upper surface 22 of the rear step 20.

Another wall is a center wall 36 that extends downwardly between the center step 18 and the rear step 20. The center wall 36 extends downwardly from a rear edge of the center step 18 and is substantially perpendicular to the upper surface 22 of the center step 18. A front wall 38 extends downwardly between the front step 16 and center step 18. The front wall 38 extends downwardly from a front edge of the center step 18 and is substantially perpendicular to the upper surface 22 of the center step 18. Each of the walls 32 is substantially parallel to one another. In addition, each of the walls 32 defines a space therebetween for holding additional bottles 14.

While the walls 32 are shown extending from the bottom member 30 to the front or rear edge of each corresponding step 16, 18, 20, it should be noted that the walls 32 could have a different form. While the walls 32 may provide some stability to the overall structure of the rack 10, the structure could be made stable without using the walls 32. As will be discussed below, the walls 32 also provide a guide for the slide-out trays 12. Partial height walls could alternatively be used, if it is determined that the walls 32 are not necessary for stability. Reduction in the size of the walls 32 could also result in a cost reduction for the product since lesser material would be needed to produce the parts.

The stepped upper member has an upper surface 22 on which the bottles 14 rest, and a lower surface 40 that faces downwardly. The open space 24 is positioned below the lower surface 32. The upper surface 22, or platform, of each step 16, 18, 20 includes an upwardly extending railing 28 that extends around an outer perimeter of each of the steps 16, 18, 20. This railing 28 helps to retain a bottle 14 on the corresponding step.

The open space 24 below each step 18, 20, can be sized to accept differently size items 14. For example, the space 24 below the center step 18 will be shorter in height than the space 24 below the rear step 20. If desired, an additional horizontal support could be provided under the upper step 20 (not shown) for positioning an additional row of bottles or items 14 so that two spaces will be provided below the upper step 20.

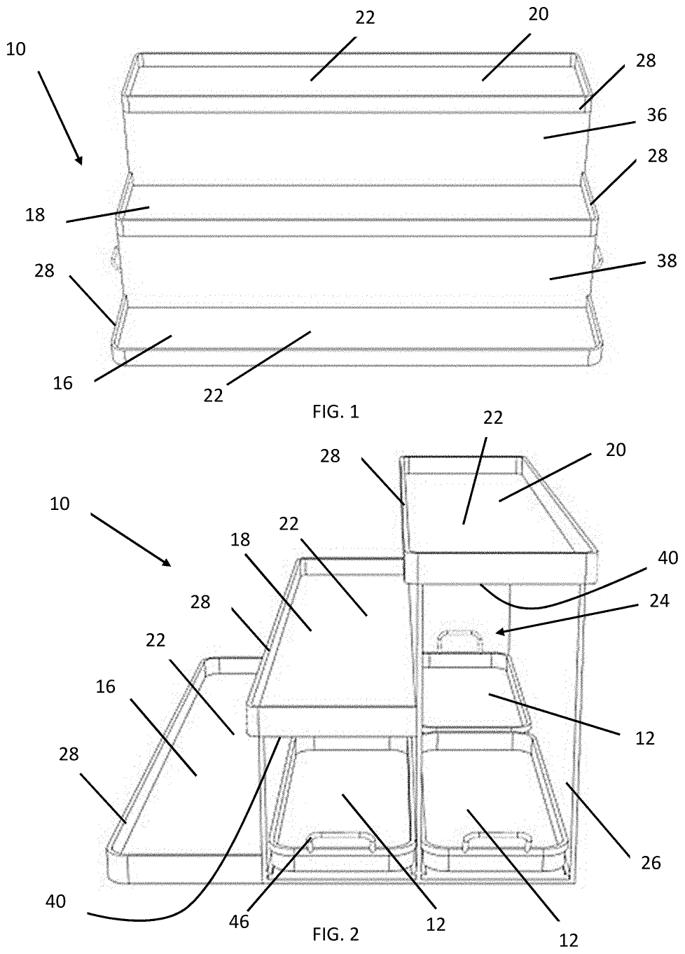

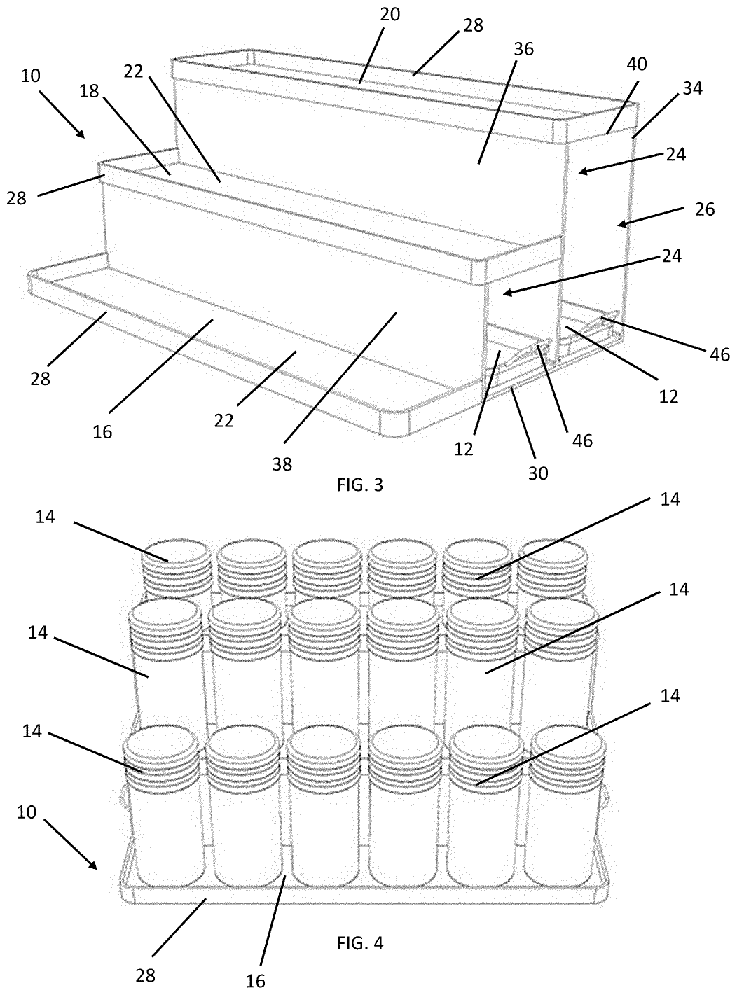

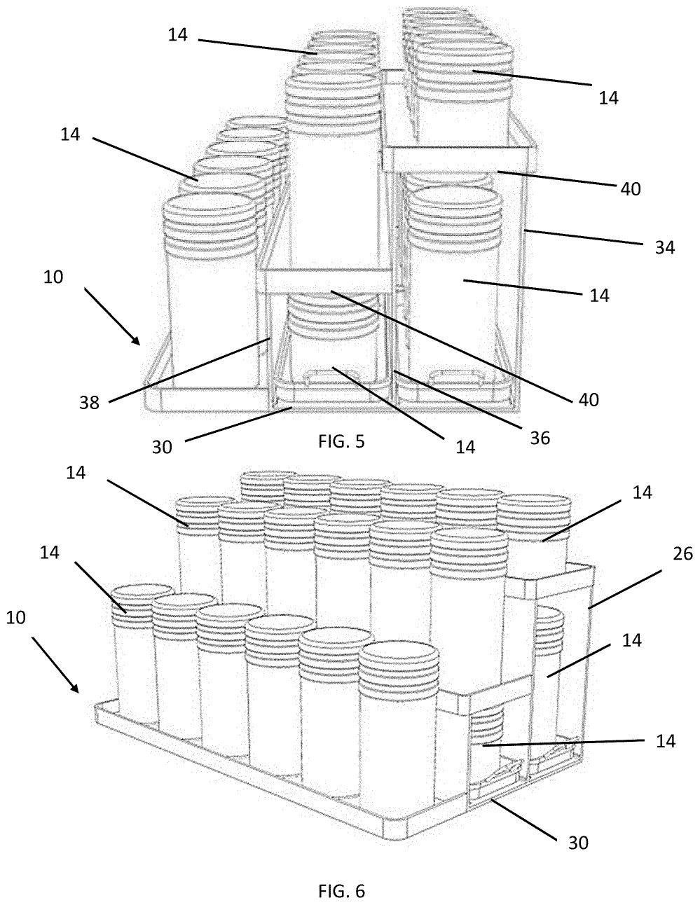

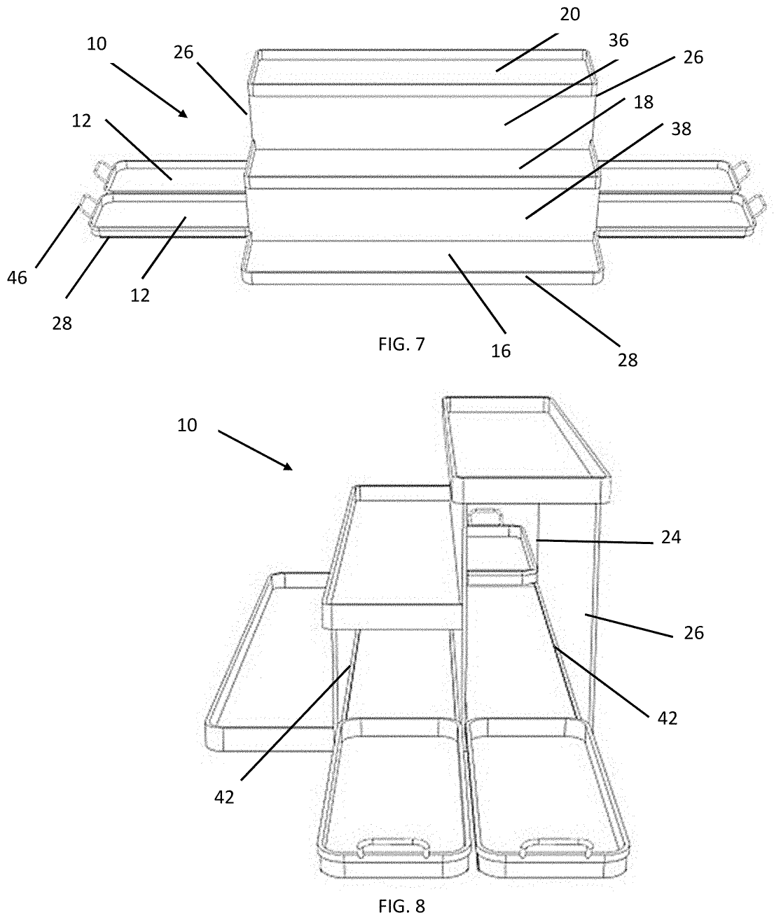

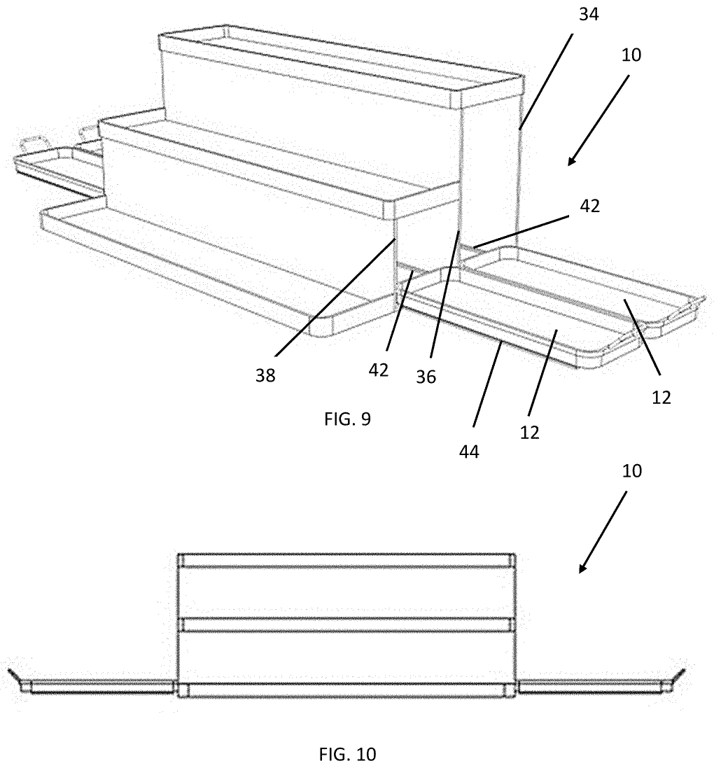

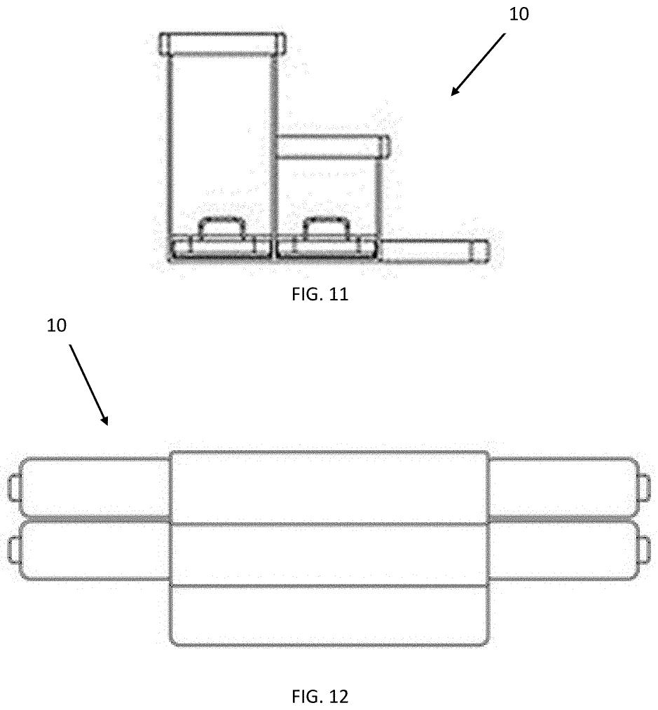

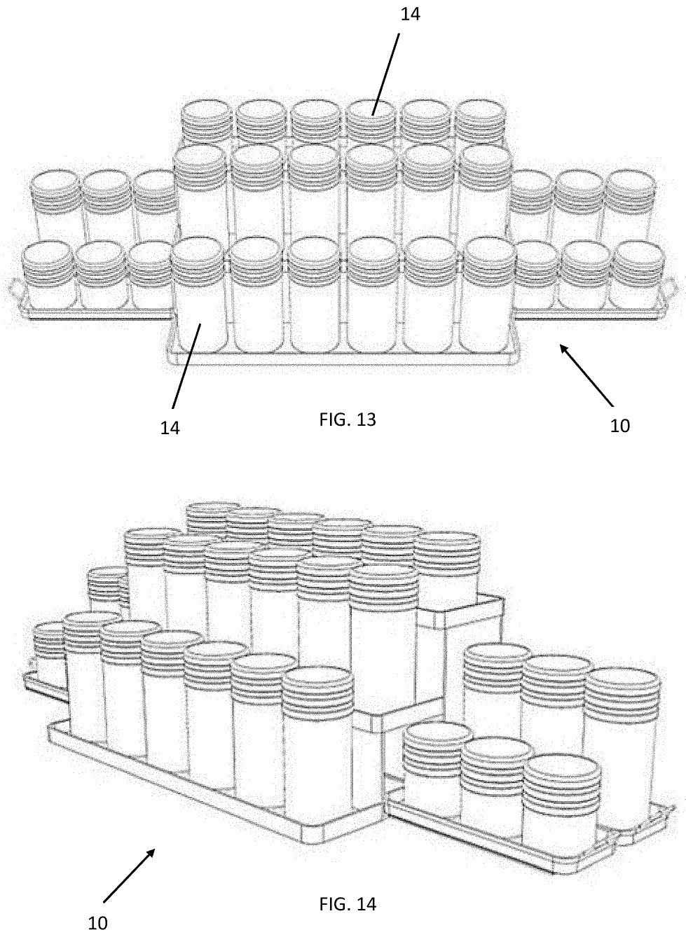

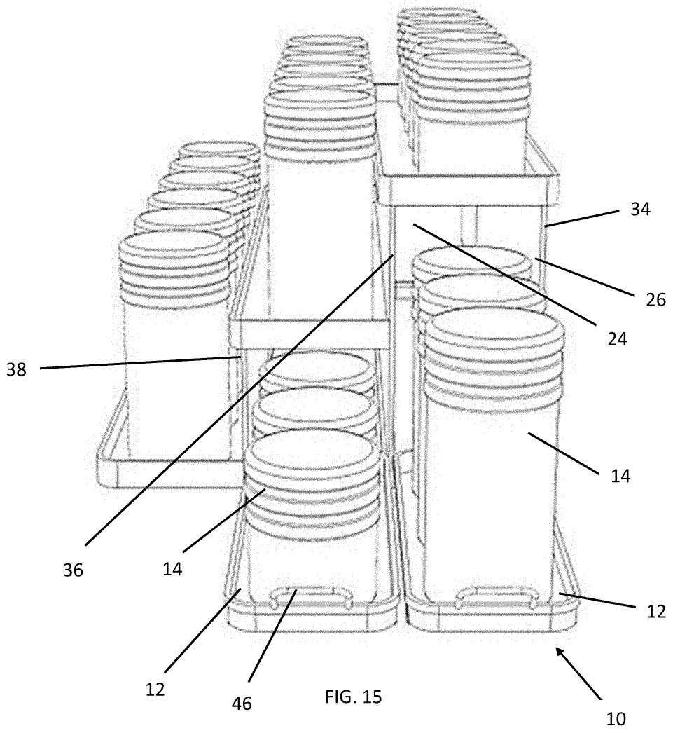

As discussed above, the spice rack 10 has a closed configuration where the slide-out trays 12 are hidden under the stepped upper member, and an open configuration where the slide-out trays 12 are extended outwardly from the stepped upper member so that any bottles 14 positioned on the slide-out trays 12 are reachable and visible. The closed configuration is shown in FIGS. 1-6, and the open configuration is shown in FIGS. 7-15. The open configuration substantially doubles the width of the spice rack 10. It also increases the number of bottles 14 that can be stored on the rack 10 as if two additional steps were provided.

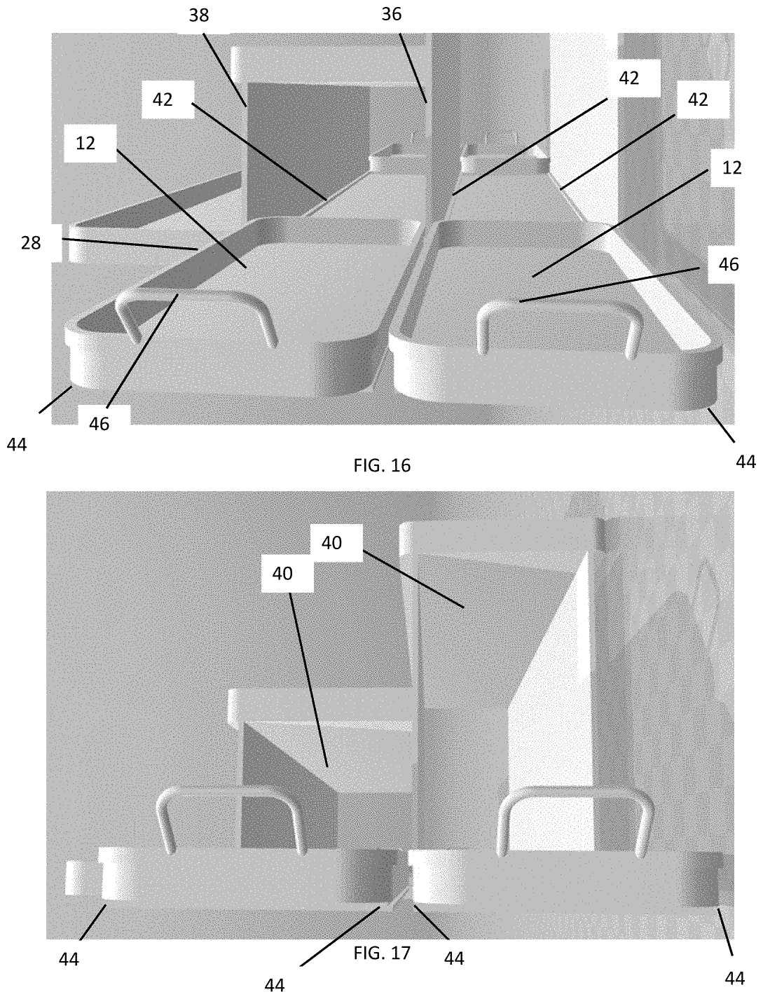

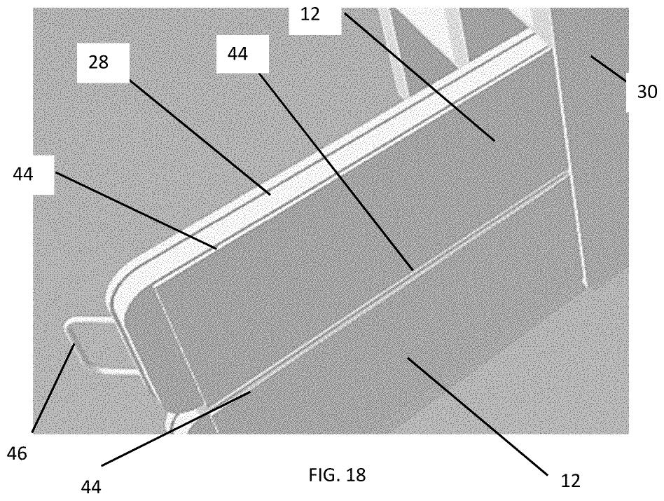

The slide-out trays 12 are shown seating against the bottom member 30 of the spice rack 14. Sliding mechanisms are shown provided to permit the slide-out trays to slide in and out of the open space. As shown in FIGS. 16-18, the sliding mechanisms can be positioned on the walls 32, 34, 36, 38 and on the sliding trays 12. Alternatively, and not shown, the sliding mechanisms could be associated with one of the sliding trays 12 or the walls 32, 34, 36, 38. The slide-out trays may also include upwardly extending railings 28 extending around their perimeters.

In one embodiment, the walls 32, 34, 36, 38 include opposing rails 42 that extend inwardly from the walls 32, 34, 36, 38 and that extend substantially along the length of the walls 32, 34, 36, 38. The length of the walls 32, 34, 36, 38 is defined as the length from left to right of the upper surfaces 22 of the rack 10. The slide-out trays 12 are shown as including longitudinally extending recesses or indentations 44 that permit the slide-out trays 12 to slide onto the rails 42 of the walls 32, 34, 36, 38 so that the slide-out trays 12 can slide or ride on the rails 42. While rails 42 are shown, other types of sliding mechanisms may be provided. In addition, if desired, the trays 12 could simply seat on the bottom member 30 without any type of sliding mechanisms.

While a bottom member 30 is shown, the spice rack 10 could be manufactured without the bottom member 30, if desired. Such a design would likely cost less because less material would be needed to manufacture the part. In the case where a bottom member 30 is not used, the inner walls 32, 34, 36, 38 could be used to provide a support structure for the steps 16, 18, 20, and sliding mechanisms could be positioned on the lower end of the walls 32, 34, 36, 38 for mating with the sliding trays 12. If a bottom member 30 is not provided, the trays 12 could simply seat on an underlying surface.

A stop member (not shown) may be provided on the slide-out trays 12 so that the trays may not be easily removed from the spice rack 10. One of ordinary skill in the art could design such a stop member.

Other types of sliding mechanisms may be utilized, as known by those of skill in the art. While three 16, 18, 20 steps are shown, more than three steps could be included, or fewer than three steps could be included. While the walls 32, 34, 36, 38 are shown as being solid, they could include openings, such as openings that permit airflow through the device. In one embodiment, the bottom edges of the walls 32, 34, 36, 38, even if partial height walls, are solid so that the sliding mechanism can extend along the length of each of the walls 32, 34, 36, 38. The steps 16, 18, 20 are shown as being substantially equal in height and width. Alternatively, the steps 16, 18, 20 could have different heights or widths. For example, the bottom step 16, could be wider than the center step 18. The center step 18 could be wider than the upper step 20. This would allow the device to be readily used in a corner, for example. The opposite is also true.

The slide-out trays 12 can include handles 46 that assist the user in removing the slide-out trays 12 from the open space 24. The handles 46 may be positioned on one or both ends of the slide-out trays 12.

While two trays 12 are shown positioned in each open space 24 between the walls 32, 34, 36, 38, a single tray 12 that only extends from one open side of the rack 10 could be utilized in each open space 24.

According to one embodiment of the invention, a storage rack having a hidden section for storing additional items includes a stepped base member, an open space, at least one open side, one or more slide-out trays, and a plurality of upstanding walls. The stepped base member has an upper member that defines at least two or more steps for storing items and a lower member that seats directly against a surface on which the storage rack seats. The lower member is substantially planar. The upper member has an upwardly facing surface and a downwardly facing surface. The downwardly facing surface is positioned on a lower side of the stepped base member. The open space is provided under the lower surface. The open space is of a size to permit storage of items therein. The stepped member includes at least one open side. The one or more slide-out trays are positioned between the stepped base member and the lower member. The slide-out trays are slidable out of the storage rack at the at least one open side of the stepped base member. The plurality of substantially vertical walls couple the stepped base member to the lower member at a plurality of positions between the front and rear of the stepped base member. At least some of the walls include means for holding the slide-out trays. The slide-out trays include members for coupling with the means for holding the slide-out trays. The trays are slidable along the lower member in a direction that aligns with a length of the steps of the stepped base member.

The stepped base member may include three steps, four slide-out trays, and three walls. A front wall is positioned between the first and the second step. A center wall is positioned between the second and the third step. A rear wall is positioned behind the third step. Two of the slide-out trays are positioned between the front and center wall. Two of said slide-out trays are positioned between the center and rear wall.

Adjacent walls may include opposing rails positioned near the bottom of the walls. Each of the slide-out trays may include recesses on opposite sides thereof for receiving the rails, with the slide-out trays sliding inwardly and outwardly from the open space along the rails. The storage rack may also include a stop means positioned on the slide-out trays to prevent the slide-out trays from disengaging with the corresponding walls.

The stepped base member may include two or more steps and each of the steps may include a railing positioned around the perimeter of the step. The railing assists in maintaining an item on the step. Each of the steps may have an upper planar surface for storing items. Each of the slide-out trays may include an upwardly extending railing positioned around the perimeter thereof. The railing may assist in maintaining an item on the corresponding slide-out tray. Each of the slide-out trays may include an outwardly extending handle utilized for sliding the corresponding tray out of the open space.

The storage rack may be made of plastic. The storage rack may be made of acrylic.

In another embodiment of the invention, a storage rack having a hidden section for storing additional items includes a stepped upper member, an open space, at least one open side, one or more slide-out trays, and a plurality of vertical walls. The stepped upper member defines at least two or more steps for storing items thereon. Each step has a substantially planar upper surface. Each upper surface defines a length of the stepped upper member between a left and a right side of each step. The upper member has an upwardly facing surface and a downwardly facing surface. The downwardly facing surface is positioned on a lower side of the stepped upper member. The open space is provided beneath the lower surface. The open space is of a size to permit storage of items thereunder. The stepped upper member has at least one open side for receiving the slide-out trays. The slide-out trays are positioned below the downwardly facing surface of the stepped upper member. The slide-out trays are slidable out of the storage rack at the at least one open side of the stepped upper member. The plurality of substantially vertical walls are coupling to the stepped upper member and extend downwardly therefrom between the front and rear of the stepped upper member. The walls provide a slot for receiving the slide-out trays and permit the slide-out trays to move along the length of the storage rack in the open space.

The storage rack may include three steps on the stepped upper member. A front step has a lower height. A center step has an intermediate height. A rear step has a greatest height. The height of the front step may be substantially zero.

The plurality of substantially vertical walls may be solid. At least some of the walls may include means for holding the slide-out trays and for permitting the slide-out trays to slide along the length of the rack in the open space. The slide-out trays may be sized to receive items that are hidden from view when the slide-out trays are positioned inside the open space. The storage rack may include three walls. A front wall is positioned between the first and the second step. A center wall is positioned between the second and the third step. A rear wall is positioned behind the third step and defines the rear of the storage rack.

Two slide-out trays may be positioned between the front and center wall. Two slide-out trays may be positioned between the center and rear wall. The plurality of substantially vertical walls may include opposing rails positioned near the bottom of the walls and each of the slide-out trays may include recesses on opposite sides thereof for receiving the rails, with the slide-out trays sliding along the rails.

Each of the steps may include an upwardly extending railing positioned around the perimeter thereof. The railing may assist in maintaining an item on the corresponding step. Each of the slide-out trays may include an upwardly extending railing positioned around the perimeter of each of said slide-out trays. The railing may assist in maintaining an item on the corresponding slide-out tray.

The storage rack may be made of plastic, wood, metal, glass, or other materials, as known by those of skill in the art.

The term “substantially,” if used herein, is a term of estimation.

While various features are presented above, it should be understood that the features may be used singly or in any combination thereof. Further, it should be understood that variations and modifications may occur to those skilled in the art to which the claimed examples pertain. The examples described herein are exemplary. The disclosure may enable those skilled in the art to make and use alternative designs having alternative elements that likewise correspond to the elements recited in the claims. The intended scope may thus include other examples that do not differ or that insubstantially differ from the literal language of the claims. The scope of the disclosure is accordingly defined as set forth in the appended claims.

What is claimed is:

1. A storage rack having a hidden section for storing additional items comprising:
a stepped base member having an upper member that defines at least two or more steps for storing items, and a lower member that seats directly against a surface on which the storage rack seats, said lower member being substantially planar, with the upper member having an upwardly facing surface and a downwardly facing surface, with the downwardly facing surface being positioned on a lower side of the stepped base member;
an open space provided under the lower surface, with said space being of a size to permit storage of items therein;
at least one open side of the stepped base member;
one or more slide-out trays positioned between the stepped base member and the lower member, said slide-out trays slidable out of the storage rack at the at least one open side of the stepped base member; and
a plurality of substantially vertical walls coupling the stepped base member to the lower member at a plurality of positions between the front and rear of the stepped base member, with at least some of the walls including means for holding the slide-out trays,
wherein the slide-out trays include members for coupling with the means for holding the slide-out trays, with the trays being slidable along the lower member in a direction that aligns with a length of the steps of the stepped base member.

2. The storage rack of claim 1, wherein the stepped base member includes three steps, four slide-out trays, and three walls, with a front wall being positioned between the first and the second step, a center wall being positioned between the second and the third step, and a rear wall being positioned behind the third step, with two of said slide-out trays being positioned between the front and center wall, and two of said slide-out trays being positioned between the center and rear wall.

3. The storage rack of claim 1, wherein adjacent walls include opposing rails positioned near the bottom of the walls and each of the slide-out trays includes recesses on opposite sides thereof for receiving the rails, with the slide-out trays sliding inwardly and outwardly from the open space along the rails.

4. The storage rack of claim 3, further comprising a stop means positioned on the slide-out trays to prevent the slide-out trays from disengaging with the corresponding walls.

5. The storage rack of claim 1, wherein the stepped base member includes two or more steps and each of the steps includes a railing positioned around the perimeter of the step, said railing assisting in maintaining an item on the step.

6. The storage rack of claim 5, wherein each of said steps has an upper planar surface for storing items.

7. The storage rack of claim 1, wherein each of the slide-out trays includes an upwardly extending railing positioned around the perimeter of each of said slide-out trays, said railing for assisting in maintaining an item on the corresponding slide-out tray.

8. The storage rack of claim 1, wherein each of the slide-out trays includes an outwardly extending handle utilized for sliding the corresponding tray out of the open space.

9. The storage rack of claim 1, wherein the storage rack is made of plastic.

10. The storage rack of claim 1, wherein the storage rack is made of acrylic.

11. A storage rack having a hidden section for storing additional items comprising:
a stepped upper member that defines at least two or more steps for storing items thereon, with each step having a substantially planar upper surface, each said upper surface defining a length of the stepped upper member between a left and a right side of each said step, with the upper member having an upwardly facing surface and a downwardly facing surface, with the downwardly facing surface being positioned on a lower side of the stepped upper member;
an open space provided beneath the lower surface, with said space being of a size to permit storage of items thereunder;
at least one open side of the stepped upper member;
one or more slide-out trays positioned below the downwardly facing surface of the stepped upper member, said slide-out trays slidable out of the storage rack at the at least one open side of the stepped upper member; and
a plurality of substantially vertical walls coupling to the stepped upper member and extending downwardly therefrom between the front and rear of the stepped upper member, with the walls providing a slot for receiving the slide-out trays and permitting the slide-out trays to move along the length of the storage rack in the open space.

12. The storage rack of claim 11, wherein three steps are provided on the stepped upper member, with a front step having a lower height, the center step having an intermediate height, and the rear step having a greatest height.

13. The storage rack of claim 12, wherein the height of the front step is substantially zero.

14. The storage rack of claim 11, wherein the plurality of substantially vertical walls are solid.

15. The storage rack of claim 11, wherein at least some of the walls include means for holding the slide-out trays and for permitting the slide-out trays to slide along the length of the rack in the open space.

16. The storage rack of claim 11, wherein the slide-out trays are sized to receive items that are hidden from view when the slide-out trays are positioned inside the open space.

17. The storage rack of claim 12, wherein three walls are provided, with a front wall being positioned between the first and the second step, a center wall being positioned between the second and the third step, and a rear wall being positioned behind the third step and defining the rear of the storage rack.

18. The storage rack of claim 17, wherein two slide-out trays are positioned between the front and center wall, and two slide-out trays are positioned between the center and rear wall.

19. The storage rack of claim 11, wherein the plurality of substantially vertical walls include opposing rails positioned near the bottom of the walls and each of the slide-out trays includes recesses on opposite sides thereof for receiving the rails, with the slide-out trays sliding along the rails.

20. The storage rack of claim 11, wherein each of the steps includes an upwardly extending railing positioned around the perimeter of each step, said railing assisting in maintaining an item on the corresponding step; and
each of the slide-out trays includes an upwardly extending railing positioned around the perimeter of each of said slide-out trays, said railing for assisting in maintaining an item on the corresponding slide-out tray.
